(19) United States
(12) Patent Application Publication
(10) Pub. No.: US 2009/0103314 A1
(43) Pub. Date: Apr. 23, 2009

(54) SYSTEM AND METHOD FOR PROVIDING DECORATIVE FLUOREXCENT LIGHT FIXTURES

(75) Inventors: Casey Layne Hammer, Browns Point, WA (US); Domonique Herrin, Tacoma, WA (US)

Correspondence Address: BAKER, DONELSON, BEARMAN, CALDWELL & BERKOWITZ;Intellectual Property Department, Monarch Plaza, Suite 1600, 3414 Peachtree Rd., ATLANTA, GA, 30326, US

(73) Assignee: ILLUMINETS, LLC, Browns Point, WA (US)

(21) Appl. No.: 12/253,847

(22) Filed: Oct. 17, 2008

Related U.S. Application Data
(60) Provisional application No. 60/980,911, filed on Oct. 18, 2007.

(51) Int. Cl. F21V 11/00

(52) U.S. Cl. 362/351

(57) ABSTRACT

An apparatus for covering a ceiling light fixture with a flexible sheet having two opposing sides that define tubular passageways that each receive one of a pair of elongated rods and a plurality of fixation devices selectively attached to edge portions of the sheet and secured to a portion of a ceiling, whereby the sheet is suspended from the ceiling in covering relation to the ceiling light fixture. A method of covering a ceiling fixture is disclosed.

The present application claims the benefit of U.S. Provisional Patent Application Ser. No. 60/980,911, filed Oct. 18, 2007, and incorporated herein in its entirety by reference.

### TECHNICAL FIELD

The present invention relates generally to lighting cover systems and methods for covering lights. More particularly, but not exclusively, the present invention relates to flexible, decorative covers for use with fluorescent lights.

### BACKGROUND

Fluorescent lighting is commonly used in residential and commercial buildings due to its inexpensive cost and low energy consumption. In addition, fluorescent lights are typically mounted flush with the ceiling and are therefore often used in low ceiling height areas, such as basements or office space. Generally, fluorescent light fixtures are in a large rectangular configuration to accommodate the long fluorescent light bulb shape. In recent years, and in response to consumer dissatisfaction with the unnatural light cast by fluorescent lights, fluorescent light manufacturers have started producing natural light, pink light and other hues. Although this may produce a more pleasing light emission, the general appearance of the fluorescent light fixture has remained unchanged.

While use of fluorescent light fixtures achieves energy usage reductions over incandescent lighting, there are drawbacks to such lighting, including exposure by persons to fluorescent light and the harshness of the illumination that may bother some persons as well as impact coloring and appearances of persons and interiors.

Accordingly, there is a need in the art for an improved covering for fluorescent lighting. It is to such that the present invention is directed.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a bottom view of a system for covering a light fixture in accordance with an embodiment of the invention.

FIG. 2 is a side view of a fixation device for use in a system for covering a light fixture in accordance with an embodiment of the invention.

FIG. 3 is a perspective partially cut-away illustration of the system for covering a light fixture mounted to a ceiling in accordance with the present invention.

FIG. 4 is an end view of the cover system illustrated in FIG. 3.

FIG. 5 is an exploded detailed cut-away view of a system using a clip to connect the cover to fixation device extending from a ceiling for covering a light fixture in accordance with the present invention.

FIG. 6 illustrates an alternate embodiment of the present invention in which the cover used in the system for covering light fixtures assembles from a line cover members having mateably engageable connectors for forming an elongated cover useful with a light fixture.

FIG. 7 illustrates an alternate embodiment of the cover system

FIG. 8 illustrates a cover system for use with light fixtures in drop ceilings.

FIG. 9 illustrates an embodiment of the present invention useful with ceiling fans.

### DETAILED DESCRIPTION

### A. Overview

The present disclosure describes devices, systems and methods for covering light fixtures. It will be appreciated that several of the details set forth below are provided to describe the following embodiments in a manner sufficient to enable a person skilled in the relevant art to make and use the disclosed embodiments. Several of the details and advantages described below, however, may not be necessary to practice certain embodiments of the invention. Additionally, the invention can include other embodiments that are within the scope of the claims but are not described in detail with respect to the drawing figures.

Reference throughout this specification to “one embodiment” or “an embodiment” means that a particular feature, structure, or characteristic described in connection with the embodiment is included in at least one embodiment of the present invention. Thus, the occurrences of the phrases “in one embodiment” or “in an embodiment” in various places throughout this specification are not necessarily all referring to the same embodiment. Furthermore, the particular features, structures, or characteristics may be combined in any suitable manner in one or more embodiments. The headings provided herein are for convenience only and do not interpret the scope or meaning of the claimed invention.

The present invention is directed toward a system of covering a light fixture with a decorative panel with at least two opposing, non-snagging side edge portions in close proximity to the ceiling. The system includes a cover positioned adjacent to the light fixture and fixation devices attaching the cover in covering relation adjacent the light fixture. According to an embodiment of the invention, the cover may be a decorative fluorescent light cover constructed out of a variety of fire-resistant, flame-retardant stylish and attractive fabrics used to camouflage and conceal unattractive and unsightly fluorescent light fixtures. Alternatively, the cover may be a rigid or semi-rigid opaque or translucent panel. According to yet another embodiment, the cover may be a combination of flexible and rigid or semi-rigid panels combined to cover the entire light fixture. Alternatively the cover may cover a selected region of the light fixture, wherein the selected region may be less than or greater than the size of the light fixture.

Another embodiment of a cover for light fixtures includes individual panels suspended from the ceiling by ornamental hooks, clips, tassels, flexible hook and loop (such as Velcro® brand fasteners), or assorted fasteners of metal, plastic or other suitable material. According to one embodiment, the fixation devices are placed along two opposing sides of the cover or fabric panel and spaced at about eight to ten inches. Alternatively, fixation devices are placed along all four sides of the fabric panel. Depending on the length and size of the light fixture, placement of the fixation devices may vary. According to still further embodiments, the fixation devices along a first and third opposing sides, or ends of the panel, are different than the fixation devices along a second and fourth opposing sides of the panel. With respect to this embodiment, a variety of closures for each end is possible by single or multiple fasteners or decorative clips depending on the individual consumer needs or desires.

In yet another embodiment, a wood, plastic or metal dowel or rod is inserted down each long side of the flexible cover in a channel or passageway, defined, for example by an overlapping side portion of the fabric panel, to maintain the integrity and proper shape of the panel in non-sagging relation to the ceiling. The cover is attached to the ceiling with fixation devices, for example, plastic or metal hooks and screwed into the ceiling or double stick tape to secure and provide an anchor for suspending the cover therefrom. According to one embodiment, the cover is affixed to the ceiling and positioned to substantially encompass the fluorescent light fixture.

### B. System for Covering Light Fixtures

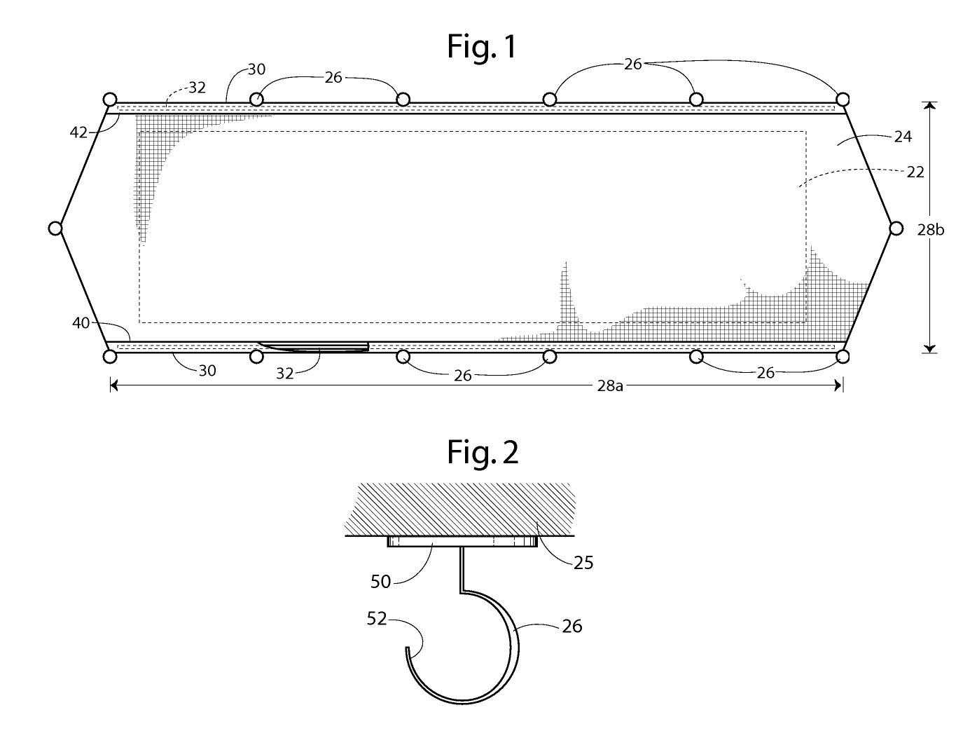

FIG. 1 is a bottom view of a system 20 for covering a light fixture 22 in accordance with an embodiment of the invention. The system 20 includes a cover 24 and fixation devices 26 to suspend the cover 24 in overlying covering relation to the light fixture attached to a ceiling 25. The cover 24 is placed adjacent to and substantially covering the light fixture 22 such as a fluorescent ceiling light. Various embodiments of the cover 24 are described in more detail.

According to one embodiment, the cover 24 includes a body of fabric having a width 28a and a length 28b. The cover 24 is sized to exceed a width and a length of a fluorescent light fixture mounted to the ceiling 25. According to this embodiment, the cover 24 creates a draping reverse-tent effect. In other words, the cover 24 depends from the opposing supports or fixation devices inwardly from a ceiling of a room. Alternatively the cover may cover a selected region of the light fixture, wherein the selected region may be less than or greater than the size of the light fixture.

The cover 24 may be a decorative light transmissive cover constructed out of a variety of fire-resistant, flame-retardant stylish and attractive fabrics used to camouflage and conceal unattractive and unsightly fluorescent light fixtures. Alternatively, the cover may be a rigid or semi-rigid opaque or translucent panel. According to yet another embodiment, the cover may be a combination of flexible and rigid or semi-rigid panels combined to cover the entire light fixture, a portion of the light fixture or a region larger than the light fixture.

The system 20 further includes an elongated member 30, such as a wood, plastic or metal dowel or rod. The elongated member 30 inserts within a passageway or channel 32 defined in opposing side edge portions of the cover 24, such as a hemmed long side or length of the fabric of the flexible cover 24. The sheet of fabric for the cover 24 includes a main portion 34 and at least two opposing side portions 36, 38 adjacent respective side edges 40, 42. The opposing side portions 36, 38 overlap towards each other. The respective side edge 40, 42 of the panel secures longitudinally to the main portion 34. This defines the opposing longitudinal side channels 32, which channels receive the respective elongated member 30. In operation, the elongated member 30 provides stability and structure to the cover 24 in order to maintain a predetermined shape. The cover 24 thereby suspends in non-sagging relation to the ceiling 25. Alternatively, the cover 24 may include a frame or other support structure to provide stability and structure when in use.

As shown in FIGS. 1, 3 and 4, the cover 24 includes fixation devices 26 that attach to opposing sides and ends of the cover. The fixation devices 26 include ornamental hooks, clips, flexible hook and loop (such as Velcro® brand fasteners) or tassels 23 or assorted fasteners either metal or plastic clipped to the fabric. The fixation devices 26 can be unitary to suspend the cover from the ceiling adjacent to the light fixture or can be a separate clip 27a and hook 27b elements that cooperatively suspend the cover 24. According to one embodiment, the fixation devices are placed along two sides (either along sides or ends) of the cover or fabric panel spaced-apart on about eight to ten inch intervals. Alternatively, fixation devices 26 are placed along all four sides of the fabric panel. As will be understood by one skilled in the art, the placement of the fixation devices 26 may vary depending on the length and size of the light fixture. According to still further embodiments, the fixation devices 26 along a first and a third side (or ends), of the panel, are different than the fixation devices along a second and fourth side of the panel. With respect to this embodiment, a variety of closures for each end is possible by single or multiple fasteners or decorative clips depending on the individual consumer needs or desires.

FIG. 2 is a side view of one exemplary fixation device 26 for use in a system for covering a light fixture in accordance with an embodiment of the invention. The fixation device illustrated in FIG. 2 includes a mounting section 50 for mounting to the ceiling (not shown for clarity) and an attachment section 52 for connecting to the cover. One skilled in the art will understand that a variety of fixation devices, such as ornamental hooks, clips, flexible hook and loop (such as Velcro®) or tassels or assorted fasteners providing an ornamental effect, and either metal or plastic may be used within the scope of the invention. According to one embodiment, the cover may be fixed firmly to the ceiling by plastic or metal hooks and screwed into the ceiling or affixed with the mounting section 50 having double stick tape or a threaded member to secure and provide an anchor from which the panels will be draped. Fixation devices may be chosen for a number of reasons, including ease of installation, decorative or ornamental features, economy, durability, removability, and/or availability.

### C. Method and System In-Operation for Covering Light Fixtures

FIGS. 1 and 3-9 illustrated various systems for covering light fixtures in accordance with an embodiment of the invention. As shown, the cover 24 of the system operates to disguise, distract, conceal and take attention away from the unsightly and off-putting glare of bright shining fluorescent lights. Further, the covers protect and shield the eye from the intensity of the rays of flaming incandescent and also act as a modern well-designed cover-up that is pleasing to the eye creating a softening of the room, which in turn creates a more relaxing and inviting environment. Various covers can provide varying degrees of shielding for the eye from overexposure of harsh, bright, intense, strong light.

Practical examples of the system in installation and use includes a doctor's office where a patient may lie on his back atop the examining table, facing upwardly into the glare of the harsh lighting cascading down from the fluorescent light fixture. The result for some is painful. Not only does the light hurt the eyes but the light creates a cold and unnerving environment. The system for covering light fixtures described above acts as a shield to protect the eyes from the overexposure along with softening the lighting to create a more relaxing experience. Yet another example of use installs the cover over lights at a dentist's office; use of these covers would give the patient something to gaze upon. For children, such is beneficial, especially if the covers were patterned with child-friendly prints, thus helping the child to breathe deeply and relax into the chair. Use of the above described system for covering light fixtures may lead to a calmer, more positive experience at a dentist, doctor or place that is otherwise a stressful environment.

The system accordingly provides an aesthetic purpose by creating ambience. The light fixture thus may not be the first thing one's eye immediately focuses on. The system instead creates a welcoming, comforting atmosphere. Additionally, fluorescent lights are ecologically friendly and by disguising them, a builder, homeowner, or employer can create a softer, soothing and more inviting atmosphere.

### D. Additional Aspects of a System for Covering Light Fixtures

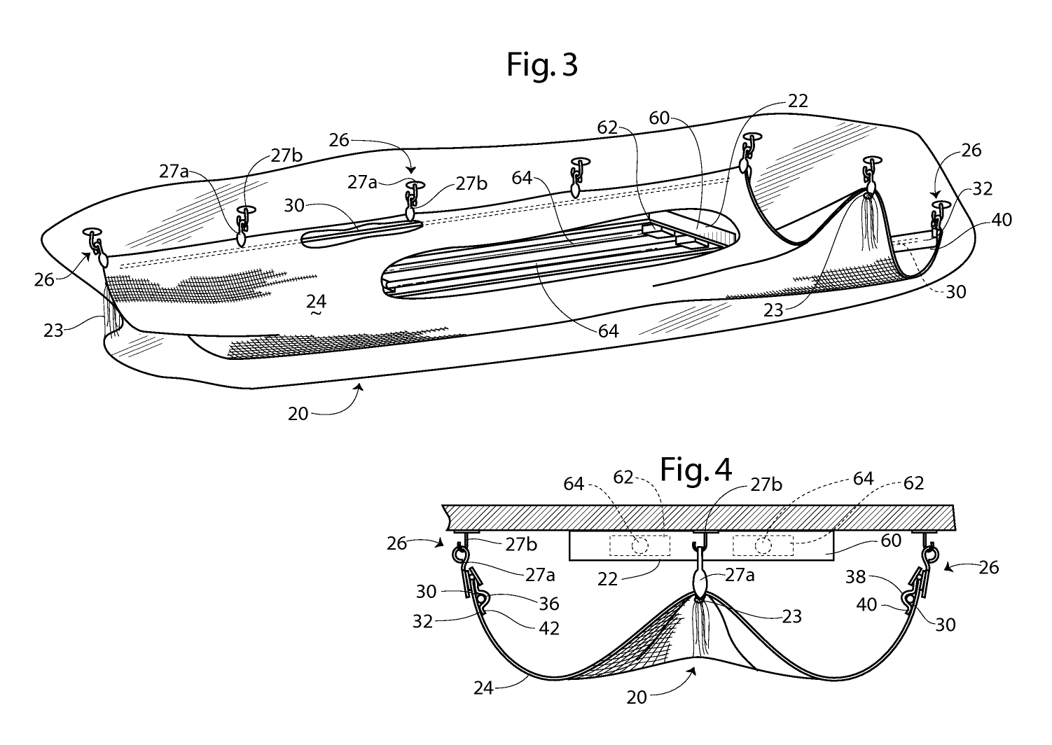

According to another aspect of the invention, a manufacture may ship the cover system as part of a lighting fixture to provide a kit. With reference to FIGS. 3 and 4, the kit includes the lighting fixture 22 with a frame 60, lamp sockets 62, lamps 64, and electrical connectors, as well as the fabric cover 24, the elongated members 30, the fixation devices 26, and connectors such as the rings. The cover system also can be sold as an accessory to lighting fixtures under particular manufacturer brand name. The cover system can further be manufactured by the lighting fixture manufacturer or by a third party manufacturer.

FIG. 5 illustrates in detailed cut-away view an exploded view of the cover 24 with the channel 32 receiving an elongated member 30. In the illustrated embodiment, the elongated member 30 comprises a plurality of interconnected tubular member 64 that attach together axially. In the illustrated embodiment, the tubular members 64 each have at least one open end 66 and an opposing end 68. A connecting pin 70 slidably inserts in aligned open ends 66 axially to connect adjacent two of the tubular members 64. Other axial connectors may be gainfully used; for example, a pin integral with one end of the member 64 inserts into an open end of another member 64 (not illustrated). The fixation device 26 connects with a threaded shaft 72 to the ceiling. A hook portion of the fixation device 26 engages a loop connected to a clip 74. The clip 74 includes a spring member to bias the clip to a closed position whereby a pair of opposing jaws 78 that grippingly engage a portion of the cover 24.

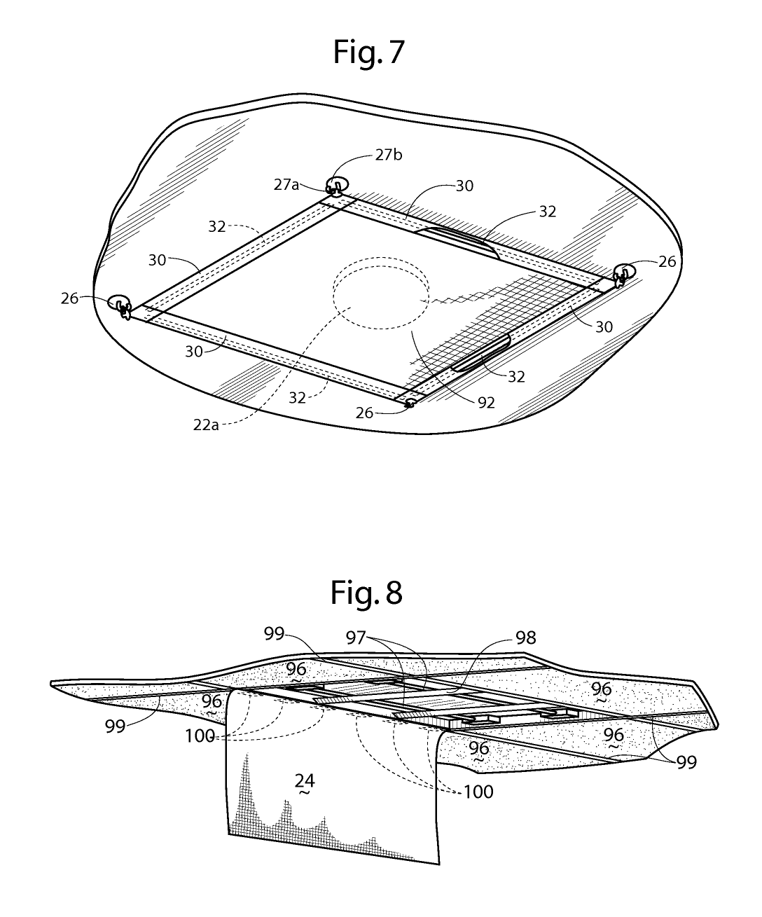

According to further aspects of the invention, with reference to FIG. 7, the system may be used ornamentally to cover portions of ceilings with spaced-apart covers 92 having a geometric shapes such as the illustrated square cover 92, for example, covering a light fixture 22a. The cover 92 includes the overlapped side edges that define channels or passageways 32 for the elongated members 30 on each side of the cover 92 (shown in partial cut-away view) rather than just two opposing sides. The cover 92 is provided in the illustrated embodiment in standard sizes of 24 inches by 24 inches, 36 inches by 36 inches, 48 inches by 48 inches, and 60 inches by 60 inches, but may be other sizes as well. The covers 92 mount as discussed above with the fixation devices 26 (unitary device) or the separate clip 27a and hook 27b elements to suspend the cover from the ceiling, although with less of a depending tent shape because of the supports on all sides of the fabric cover.

According to still further aspects of the invention, the system may be used in with drop ceilings 94, for example, having a 24″×24″ grid or a 24″×48″ grid of tiles 96 as illustrated in FIG. 8, with a light fixture 97 having a light diffuser grid 98. A plurality of tiles 96 seat on suspended T-supports 99. According to aspects of this embodiment, the cover system shown in FIG. 8 includes magnets 100 sewn into the side portions of the cover 24 to allow the cover system to attach to the metal grid supports 99 or to a metal frame of the lighting fixture 97. The cover 24 is shown with one side attached magnetically to the T-support 99. Alternatively, Velcro™ or other fixation devices compatible with the drop ceiling grid such as hooks or adhesive, could be used. The use of magnets permits a convenient means of replacing or cleaning the fabric covers as needed. This embodiment can include the passageways 30 for receiving the magnets, and including in an alternate embodiment the elongated members 32. In one embodiment, the magnets attach magnetically directly to the drop ceiling grid. In operation, the system may be fit to a standard 24″×48″ grids. Accordingly, the covers could cover be used to cover either the lights or the ceiling tiles or both. According to still further aspects of the embodiment, different patterns of fabric could be used to create a ceiling design.

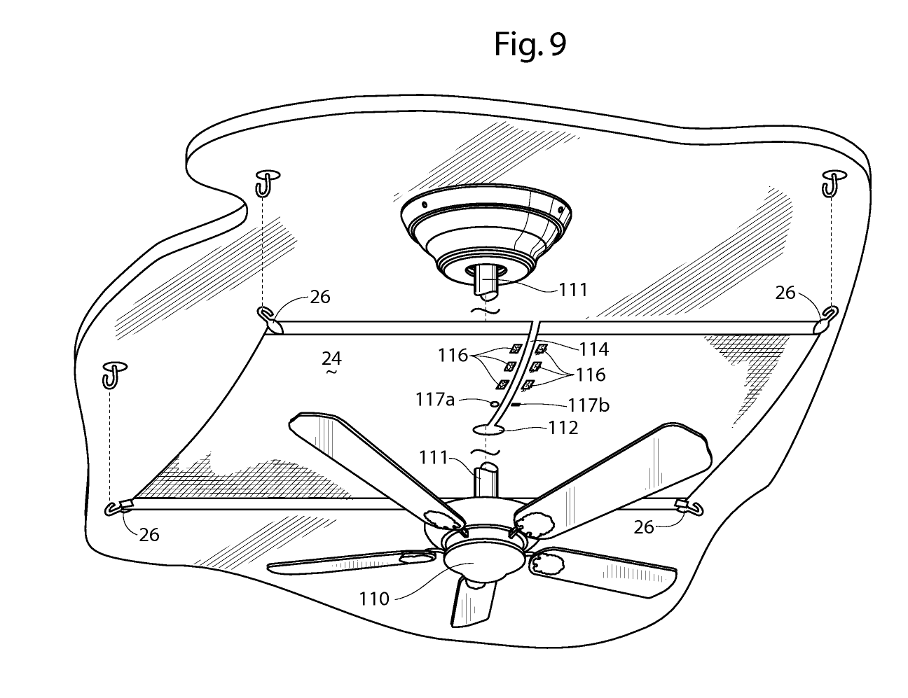

According to still further aspects of the invention, the system may be used with a ceiling fan 110 having a down pole 111 extending from a canopy attached to the ceiling, as shown in FIG. 9. The cover 24 includes a center hole 112 with a slot 114. The opposing edges of the fabric that define the slot 114 are held detachably together by fasteners 116 (shown detached) such as Velcro™ brand matingly engageable members or other fixation devices. For example, the fasteners 116 in an alternate embodiment (shown simultaneously in FIG. 9 for convenience) is a button 117a that engages an opposing slit 117b for selectively closing the slot 114. The slot 114 enables sliding the cover around the down pole 111 so the down pole occupies the hole 112. For example, the system may be used around a ceiling fan with, for example, four spaced apart fluorescent lights disposed on the ceiling 25 around the ceiling fan with the cover covering the lighting fixtures and the canopy for the ceiling fan with a pillow-drape effect while the motor and blades of the fan are disposed below the cover for moving of air in the room. This provides the cost saving of fluorescent lighting with the use of a ceiling fan, yet drapes or subdues the emitted light.

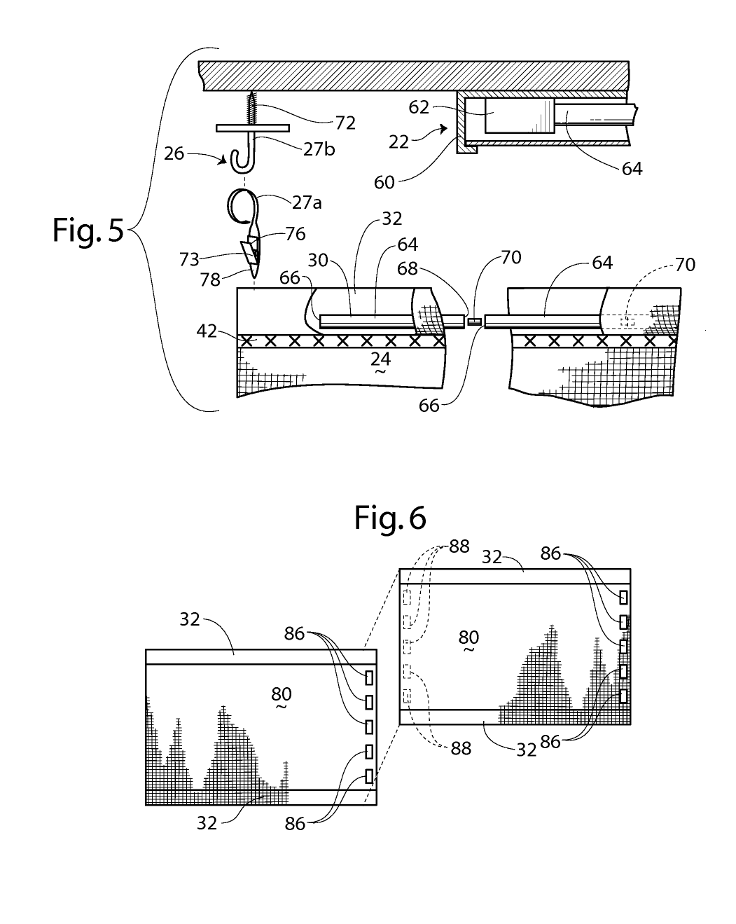

According to a further aspect of the invention, FIG. 6 illustrates a plurality of cover sections 80 as discrete units that can be joined as extensions by way of a plurality of mating Velcro strips 86, 88 or other fixation devices to allow uniform sizes of covers to be manufactured and sold. Uniform cover sizes provide an advantage in allowing an extension of the lighting covers to a selected length for covering elongated fixtures or portions of ceiling. In this embodiment, the strips 86 have a first character and attach to a first surface of the cover 80. Second strips 88 of a second character attached to an opposing surface of the cover 80. The second strips 88 align with the strips 86. Two adjacent covers 80 can be selectively attached by joining the first strips 86 to the aligned second strips 88. The covers 80 include the channels 32 for receiving the elongated members 30 as discussed above with reference to the cover 24. According to yet another aspect of the invention, the cover system may be attached directly to the ceiling with Velcro® or another fixation device known in the art. This would provide a low cost product that would be easy to install and uninstall.

It will be apparent that various changes and modifications can be made without departing from the scope of the invention. For example, the fabric of a flexible cover may be altered or varied to include assorted patterns/prints/textures. The size of the cover may be varied depending on length and size of individual light fixture, the amount of draping. The dowels or rods used to insure the shape and integrity of the panels may be changes in size, length or material stiffness to provide different looks and different levels of support. Alternatively, the fixation devices may be varied, for example, an assortment of clips can vary for hanging the panels from the hooks attached to the ceiling.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. When the claims use the word “or” in reference to a list of two or more items, that word covers all of the following interpretations of the word: any of the items in the list, all of the items in the list, and any combination of the items in the list.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the invention can be modified, if necessary, to employ covers and fixation devices with various configurations, and concepts of the various patents, applications, and publications to provide yet further embodiments of the invention.

These and other changes can be made to the invention in light of the above-detailed description. In general, in the following claims, the terms used should not be construed to limit the invention to the specific embodiments disclosed in the specification and the claims, but should be construed to include all systems that operates in accordance with the claims. Accordingly, the invention is not limited by the disclosure, but instead its scope is to be determined entirely by the following claims.

What is claimed is:

1. An apparatus for covering a ceiling light fixture, comprising:
a flexible sheet sized to substantially cover a ceiling light fixture and having two opposing sides that define tubular passageways;
a pair of elongated rods disposed within the tubular passageways; and
a plurality of fixation devices selectively attached to edge portions of the sheet and secured to a portion of a ceiling,
whereby the sheet is suspended from the ceiling in covering relation to the ceiling light fixture.

2. The apparatus as recited in claim 1, wherein the fixation devices comprise:
a first member that attaches to the sheet; and
a second member that attaches to the ceiling,
whereby the first and the second members engage together to support the sheet from the ceiling in covering relation to the ceiling light fixture.

3. The apparatus as recited in claim 2, wherein the first member comprises a clamp that grippingly engages a portion of the sheet.

4. The apparatus as recited in claim 2, wherein the first member attaches with a threaded sewn member to the sheet.

5. The apparatus as recited in claim 2, wherein the second member comprises a member having a hook that engages the first member and having a threaded stem opposing the hook for engaging the portion of the ceiling.

6. The apparatus as recited in claim 1, wherein the fixation devices comprise a plurality of spaced-apart bodies having a magnetic characteristic for attractively attaching the sheet in covering relation to a frame for the ceiling light fixture mounted in the ceiling.

7. The apparatus as recited in claim 1, wherein the fixation devices further comprise an ornamental element.

8. The apparatus as recited in claim 1, further comprising a plurality of ornamental devices attached to the sheet.

9. The apparatus as recited in claim 1, wherein the flexible sheet comprises at least a first panel and a second panel, the first panel and second panel each having a main portion and opposing side portions that overlap and each with a respective side edge of the panel secured longitudinally to the main portion to define opposing longitudinal side channels, the first panel having at least one first mating member with a first characteristic on a third side of the first panel, the second panel having at least one second mating member on a third side of the second panel with a second characteristic that is matingly detachably engageable to the first mating member, whereby the cover assembles by matingly joining the first and second panels and the respective side channels substantially coaxially aligned so that each of the opposed aligned channels receive one of the elongated rods therein.

10. The apparatus as recited in claim 1, wherein the cover further comprises opposing channels on third and forth side portions of the cover, the channels receiving an elastic member therein for the cover to closely conform to a perimeter portion of the ceiling light fixture.

11. The apparatus as recited in claim 1, wherein the cover further defines a slit extending from a side edge of the cover to a substantially central opening, whereby the cover can be disposed between a ceiling and a ceiling-mounted ceiling fan with a downstem of the ceiling fan passed along the open slot to the opening and the slot closed by joining members.

12. The apparatus as recited in claim 11, wherein opposing portions of the cover that define the edges of the slot have opposing matingly engageable members for detachably engaging so that the slot is substantially closed.

13. The apparatus as recited in claim 12, wherein the members comprise a button attached to a first portion and a slotted opening in the opposing second portion, whereby the button received in the opposing opening substantially closes the slot after positioning the downstem in the opening in the cover.

14. The apparatus as recited in claim 12, wherein a first portion has a first member with a first engaging characteristic and the second portion has a second member with a second engaging characteristic for matingly detachably engaging the first and second members.

15. The apparatus as recited in claim 1, wherein the elongated rods comprise:
a plurality of tubular members having opposing ends, at least one end being open therein; and
a pin received in open ends of two opposing tubular members for joining the members together axially.

16. A kit of a lighting fixture and the apparatus as recited in claim 1, wherein the lighting fixture mounted to the ceiling is covered by the flexible sheet suspended from the ceiling by the plurality of fixation devices and the elongated rods maintain the opposing edges in non-sagging proximity to the ceiling.

17. A method of covering a ceiling light fixture comprising the steps of:
(a) attaching a plurality of fixation devices to selected portions of a flexible sheet sized to substantially cover a ceiling light fixture, the sheet having two opposing side edge portions that define tubular passageways;
(b) attaching the fixation devices to selected portions of a ceiling on opposing sides of the ceiling light fixture, whereby the sheet is suspended depending from the ceiling in overlying relation relative to the ceiling light fixture; and
(c) inserting a pair of elongated rods within the tubular passageways to define an elongate substantially non-sagging edge on opposing side edges of the sheet
whereby the sheet overlies the ceiling light fixture in covering relation.

18. The method as recited in claim 17, wherein the elongated rods assemble from at least two tubular members each having at least one open end, and a pin received in the opposing open ends for connecting the members together axially.

19. The method as recited in claim 17, wherein the elongated rods assemble from at least two tubular members axially connected together.
